(19) United States
(12) Patent Application Publication
(10) Pub. No.: US 2011/0051655 A1
(43) Pub. Date: Mar. 3, 2011

(54) Relay System and Method in a Wireless Communications system

(75) Inventors: Yufei Blankenship, Kildeer, IL (US); Jianmin Lu, San Diego, CA (US)

(73) Assignee: FutureWei Technologies, Inc., Plano, TX (US)

(21) Appl. No.: 12/861,635

(22) Filed: Aug. 23, 2010

Related U.S. Application Data
(60) Provisional application No. 61/236,765, filed on Aug. 25, 2009.

(51) Int. Cl. H04B 7/14; H04W 36/00; H04B 7/15

(52) U.S. Cl. 370/315; 370/331; 455/11.1

(57) ABSTRACT

A system and method for transmitting data is disclosed. A preferred embodiment comprises a relay node that operates in multiple states: an active state and an idle state. When the relay node enters the idle state, the relay node will transmit a notification message to the user equipment that is attached to the relay node to notify the user equipment that the relay node is going into the idle state.

This application claims the benefit of U.S. Provisional Application No. 61/236,765, filed on Aug. 25, 2009, entitled “Relay System and Method in a Wireless Communications System,” which application is hereby incorporated herein by reference.

### TECHNICAL FIELD

The present invention relates generally to wireless communications and, more particularly, to a relay system and method in a wireless communications system.

### BACKGROUND

In wireless communication networks, a Relay Node (RN) may be used as a tool to improve, e.g., the coverage of high data rates, group mobility, temporary network deployment, cell-edge throughput, and/or to provide coverage in new areas. The RN may be wirelessly connected to a wireless communications network via a donor cell (also referred to as a donor enhanced Node B (donor eNB or D-eNB)). The RN may serve as an eNB to one or more pieces of User Equipment (UE). To the UE that is being served by the RN, the RN may appear identical to an eNB, scheduling uplink (UL) and downlink (DL) transmissions to the UE over a connection between the RN and the UE, also known as an access link. When a UE is served by more than one RN, Cooperative Multipoint Transmission/Reception (CoMP) may be made by the multiple RNs which may help to provide cooperative gain and improve the performance of the UE.

However, the RN may not be able to relay communications at all times. For example, if the RN is a mobile RN, it will move in and out the coverage area of the D-eNB, and may experience loss of service, thereby causing loss of service to the subservient UE as well. Furthermore, because the UE may remain in communication with the RN, the UE may not realize that the RN has experienced any problem, thereby preventing the UE from attempting to solve the communication loss by itself.

### SUMMARY OF THE INVENTION

Technical advantages are generally achieved, by embodiments of a system and method for access link resource allocation in a wireless communications system.

In accordance with an embodiment of the present invention, a method for transmitting data to a first piece of user equipment comprises wirelessly transmitting a first data packet from a relay node, the relay node being in a first state. The relay node enters a second state different from the first state, wherein the relay node is not accessible in the second state.

In accordance with yet another embodiment of the present invention, a method for receiving data from a relay node comprises receiving a first data packet from the relay node, the receiving being performed wirelessly, and receiving a notification message from, the notification message comprising a notice of unavailability.

In accordance with yet another embodiment of the present invention, a system for transmitting data comprises a relay node, wherein the relay node is configured to enter into a second mode from a first mode, and a wireless transmitter coupled to the relay node, the transmitter configured to transmit a message comprising information regarding the relay node entering the second mode.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1 illustrates a wireless communications system in accordance with an embodiment of the present invention;

FIG. 2 illustrates uplink (UL) and downlink (DL) paths that may occur in a transmission in accordance with an embodiment of the present invention;

FIG. 3 illustrates three separate states into which a piece of user equipment may operate in accordance with an embodiment of the present invention; and

FIG. 4 illustrates three separate states into which a relay node may operate in accordance with an embodiment of the present invention.

Corresponding numerals and symbols in the different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

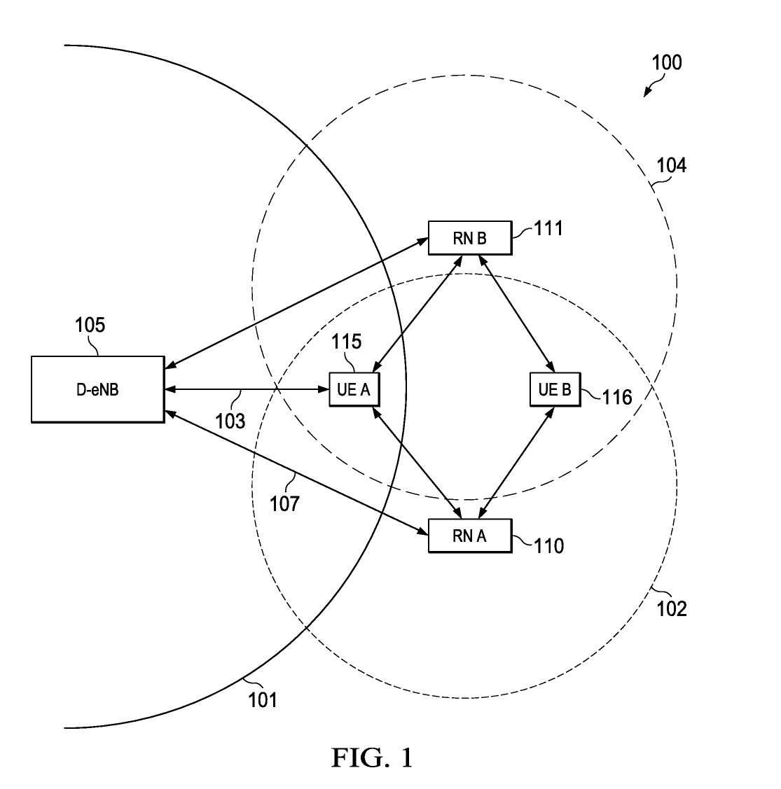

FIG. 1 illustrates a wireless communications system 100 that may include a base station 105, a first relay node (RN) 110, a second RN 111, a first piece of user equipment (UE) 115 and a second UE 116. The base station 105 may be, e.g., a donor enhanced Node B (donor eNB or D-eNB), an access network, an access point, or the like. The base station 105 may have a corresponding coverage area 101, wherein a UE, such as the first UE 115, that is within the coverage area 101 may communicate directly with the base station 105 (as indicated in FIG. 1 by line 103).

The first RN 110 may wirelessly communicate with the base station 105 through, for example, a backhaul connection (represented in FIG. 1 by line 107), and may be used to relay data from the base station 105 to, e.g., the first UE 115 or the second UE 116 (both of which are described further below) which may be located within a second coverage area 102 of the first RN 110. Such a relay of data may occur through a transmission associated with the first RN 110 and may help to extend the effective range of the base station 105 as it allows a piece of user equipment (such as the second UE 116) to be located outside of the first coverage area 101 but remain within the second coverage area 102 of the first RN 110.

The first RN 110 may comprise a fixed node, which does not move its position in relation to the base station 105. Alternatively, the first RN 110 may comprise a mobile node. For example, the first RN 110 may be located on a movable station, such as a bus or train, such that the first RN 110 may move into and out of communication range of the base station 105.

Additionally, the first RN 110 may be a regenerative type RN, wherein the received signal is decoded and then forwarded. Once received and decoded, the signal may be scheduled for forwarding towards the destination using a suitable radio resource management strategy. Alternatively, the first RN 110 may be a non-regenerative RN, wherein the signal is merely amplified by the first RN 110 and simply forwarded to the next station, such as the base station 105.

The second RN 111 may be similar to the first RN 110, but is not necessarily the same as the first RN 110. As such, the second RN 111 may be a fixed or mobile RN that may utilize either a regenerative or non-regenerative type of transmission. The second RN 111 may have a third coverage area 104 which may overlap a portion of the second coverage area 102 and the first coverage area 101.

The first UE 115 may comprise any device that desires to communicate, either directly or indirectly, with the base station 105. The first UE 115 may change its location within the wireless communications system 100. The first UE 115 may include mobile phones, personal data assistants (PDAs), notebook computers, other computers that have a wireless connection with the base station 105, or the like, and any suitable device that may be used to transfer data between itself and the base station 105 (through, e.g., a transceiver) may be used as the first UE 115.

The first UE 115 preferably utilizes release 10 of the 3GPP wireless communication specification (3GPP Rel-10) or later versions of the 3GPP wireless communication specification. However, the present embodiments are not limited to only this wireless communication specification. For example, the Worldwide Interoperability for Microwave Access (WiMAX), Evolution-Data Optimized EV-DO, or Universal Mobile Telecommunications System (UMTS) communication standards may alternatively be utilized. These standards and all other suitable standards are fully intended to be included within the scope of the present embodiments. Additionally, the present embodiments may be modified as described more fully below to be backwards compatible with previous versions of the 3GPP specification.

Additionally, the first UE 115 may be currently located within the first coverage area 101 of the base station 105. As such, the first UE 115 may communicate directly with the base station 105 if desired. Such communications may be performed in order to maintain, e.g., a control channel with no data traffic or else to receive data packets from both the base station 105 and the first RN 110 or second RN 111 in order to increase the traffic flow to the first UE 115.

The first UE 115 may also be located within an overlapping region of the second coverage area 102 and the third coverage area 104, wherein it may be capable of receiving transmissions from both the first RN 110 and the second RN 111 through, for example, a wireless connection such as an access link. In this location, the performance of the first UE 115 may be improved by transmitting multiple instances of the same data and utilizing, e.g., Cooperative Multipoint Transmission/Reception (CoMP) to achieve cooperative gain, to the first UE 115.

The second UE 116 may be similar to the first UE 115, but does not necessarily need to be the same. As such, the second UE 116 may include mobile phones, personal data assistants (PDAs), notebook computers, other computers that desire to communicate, either directly or indirectly, with the base station 105, and any suitable device that may be used to transfer data from itself to the base station 105 may be used as the second UE 116. All such devices are fully intended to be included within the scope of the present embodiments.

Additionally, the second UE 116 may be located outside of the coverage area 101 of the base station 105. However, by remaining with either the second coverage area 102 of the first RN 110 or the third coverage area 104 of the second RN 111, the second UE 116 may communicate with the base station 105 by relaying its transmissions through either the first RN 110 or the second RN 111. In other words, communications between the second UE 116 and the base station 105 may be relayed through the first RN 110 or the second RN 111.

The wireless communication system 100 may utilize a communication standard such as the 3GPP LTE-Advanced standard in order to standardize the communications such as described in 3GPP TS 36.331 V8.5.0 (2009-03), Evolved Universal Terrestrial Radio Access (E-UTRA); Radio Resource Control (RRC); Protocol specification, and 3GPP TR 36.814 V1.2.1 (2009-06), “Further Advancements for E-UTRA; Physical Layer Aspects; (Release 9),” both of which are hereby incorporated herein by reference. The 3GPP LTE-Advanced standard with relaying helps to improve the wireless network by improving the coverage of high data rates, group mobility, temporary network deployment, the cell-edge throughput and/or to provide coverage in new areas

However, as one of ordinary skill in the art will recognize, the 3GPP LTE-Advanced standard is merely an exemplary standard that may be utilized and is not meant to limit the present embodiments in any fashion. Other standards, such as Worldwide Interoperability for Microwave Access (WiMAX) or Universal Mobile Telecommunications System (UMTS), may alternatively be utilized while remaining within the scope of the present embodiments. All of these standards and any other suitable standard may be utilized, and all such standards are fully intended to be included within the scope of the present embodiments.

For example, as discussed in “Further Advancements for E-UTRA; Physical Layer Aspects; (Release 9), some resources in the time-frequency space may be set aside in order to allow for inband backhauling of the relay traffic between, e.g., the first RN 110 and the base station 105 (which may be a eNodeB in one embodiment).

For inband relaying, the backhaul link between the base station 105 and, e.g., the first RN 110, may operate in the same frequency spectrum as the access link between the first RN 110 and, e.g., the first UE 115. Due to the first RN's 110 transmitter causing interference to its own receiver, additional isolation may be warranted for simultaneous transmissions from both the base station 105 to the first RN 110 and also from the first RN 110 to the first UE 115 on the same frequency resource. Such isolation may be provided, e.g., by means of specific, well separated and well insolated antenna structures. Similarly, at the first RN 110 it may not be possible to receive UE transmissions simultaneously with the first RN 110 transmitting to the base station 105.

Such an interference problem may be handled by operating the first RN 110 such that the first RN 110 is not transmitting to, e.g., the first UE 115 when it is supposed to receive data from the base station 105. In other words, “gaps” may be created in the first RN 110-to-first UE 115 transmission. These “gaps,” during which terminals (including Rel-10 and Rel-8 terminals) are not supposed to expect any relay transmission, may be created by configuring multicast/broadcast single frequency network (MBSFN) subframes. Base station 105-to-first RN 110 transmissions can be facilitated by not allowing any normal relay-to-terminal transmissions in some subframes.

FIG. 2 illustrates uplink (UL) and downlink (DL) paths that may occur in transmissions between the base station 105 and a directly connected UE (e.g., the first UE 115 and the base station 105), and transmissions between the base station 105 and a UE indirectly connected to it via a relay node (e.g., the second UE 116, the first RN 110, and the base station 105) In this embodiment, the DL paths are transmitted along a first frequency band (F1) and the UL paths are transmitted along a second frequency band (F2).

As shown in FIG. 2, the first RN 110 may be an intermediary node between the base station 105 and the second UE 116. As such, the first RN 110 may behave in a different mode towards the base station 105 than it does towards the second UE 116. For example, the first RN 110 may operate in a UE mode towards the base station 105 while operating in a base station mode towards the second UE 116. Since the first RN 110 is not a dedicated base station, the first RN 110 may provide additional information such as its buffer size, the fact that it is wirelessly connected to a base station, or the state of its wireless backhaul, to the second UE 116 in order to notify the second UE 116 on top of the information a dedicated base station 105 (such as an eNodeB) sends to its UEs.

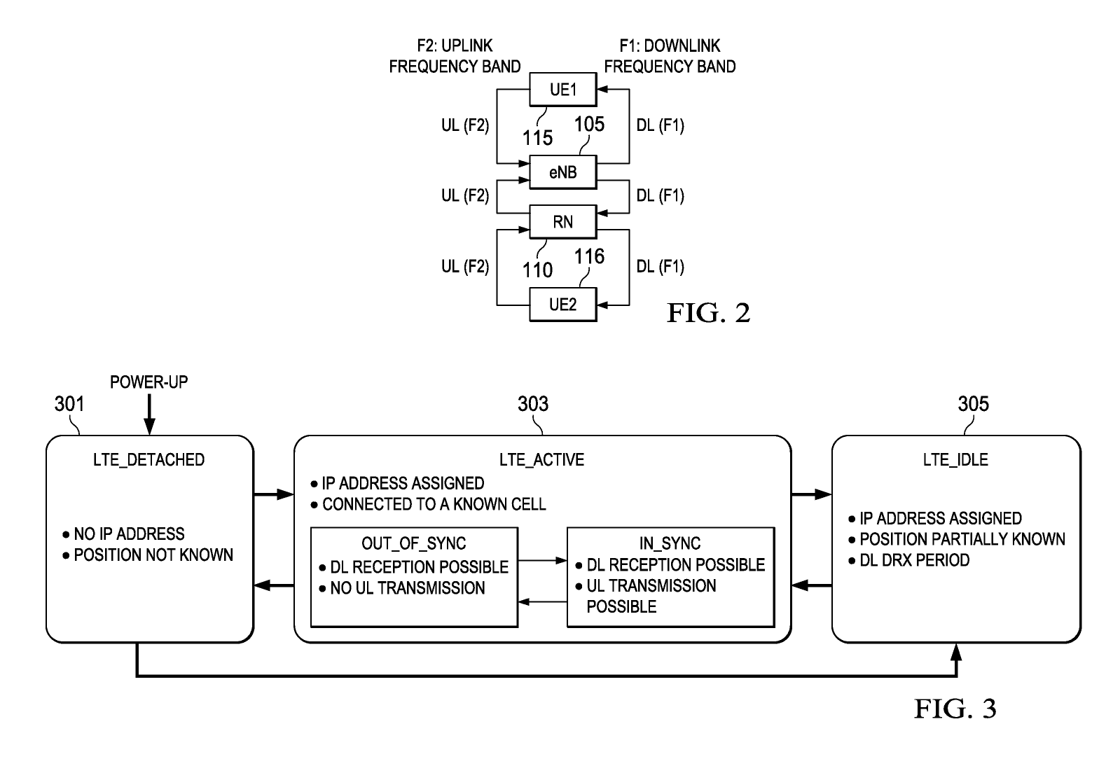

FIG. 3 illustrates three separate states into which a UE, such as the first UE 115, may operate when it is attached and communicating with the base station 105 in, e.g., the LTE-Advanced communications standard. The first UE 115 may be in an “LTE DETACHED” state 301 during a power up and start up of the first UE 115. In the “LTE DETACHED” state 301 the first UE 115 may not have an assigned address and the position of the first UE 115 may not be known to either the first UE 115 or the base station 105. The “LTE DETACHED” state 301 may be a transitory state in which the first UE 115 is powered-on but is in the process of searching and registering with the network.

Once the first UE 115 communicates with the base station 105, is assigned an address, such as an IP address, and is attached to the base station 105 for receiving and transmitting, the first UE 115 may operate in an “LTE ACTIVE” state 303. In the “LTE ACTIVE” state 303, the first UE 115 may actively receive and transmit data packets from and to the base station 105. In the “LTE ACTIVE” state 303, the first UE 115 is registered with the network and has a radio resource control (RRC) connection with the base station 105. In the “LTE ACTIVE” state 303, the network knows the cell to which the first UE 115 belongs and can transmit/receive data from the first UE 115. If the first UE 115 is in synchronization with the base station 105, the first UE 115 may receive DL transmissions while also transmitting UL transmissions. If the first UE 115 is out of synchronization with the base station 105, the first UE 115 may receive DL transmissions from the base station 105.

Additionally, the first UE 115 may have the “LTE IDLE” state 305 which may be a power-conservation state for the first UE 115, where the first UE 115 may not be transmitting or receiving packets. In the “LTE IDLE” state 305, no context about the first UE 115 is stored in the base station 105. In this state, the location of the first UE 115 may only be known at the mobility management entity (MME) and only at the granularity of a tracking area (TA) that consists of multiple base stations 105. The MME knows the TA in which the first UE 115 last registered and paging may be used to locate the first UE 115 to a cell. For example, there may be periods when the first UE 115 receives discontinuous DL transmissions (DL DRX) from the base station 301. With these discontinuous transmissions the base station 105 may only partially know the position of the first UE 115 while the first UE 115 may still have the IP address assigned to it, and may not fully receive transmissions sent to the first UE 115. During the “LTE IDLE” state 305 the first UE 115 idles itself until it re-establishes communication with either the base station 105 to which it had been attached or else can establish communication with another base station (not shown), for example in a handoff situation. Once a connection has been re-established, the first UE 115 may exit the “LTE IDLE” state 305.

Also shown in FIG. 3 are the possible movements of the first UE 115 between the different states. As illustrated, the first UE 115 may move between any of the states to any of the other states. For example, the first UE 115 may move from the “LTE ACTIVE” state 303 to either the “LTE IDLE” state 305 or the “LTE DETACHED” state 301, depending upon, e.g., the transmitting and receiving characteristics at the time of the transfer. For example, the first UE 115 may enter into the “LTE IDLE” state 305 from the “LTE DETACHED” state 301 when a connection is lost between the first UE 115 and the base station 105. Additionally, the first UE 115 may transfer from the “LTE Detached” state to the “LTE IDLE” state if conditions warrant.

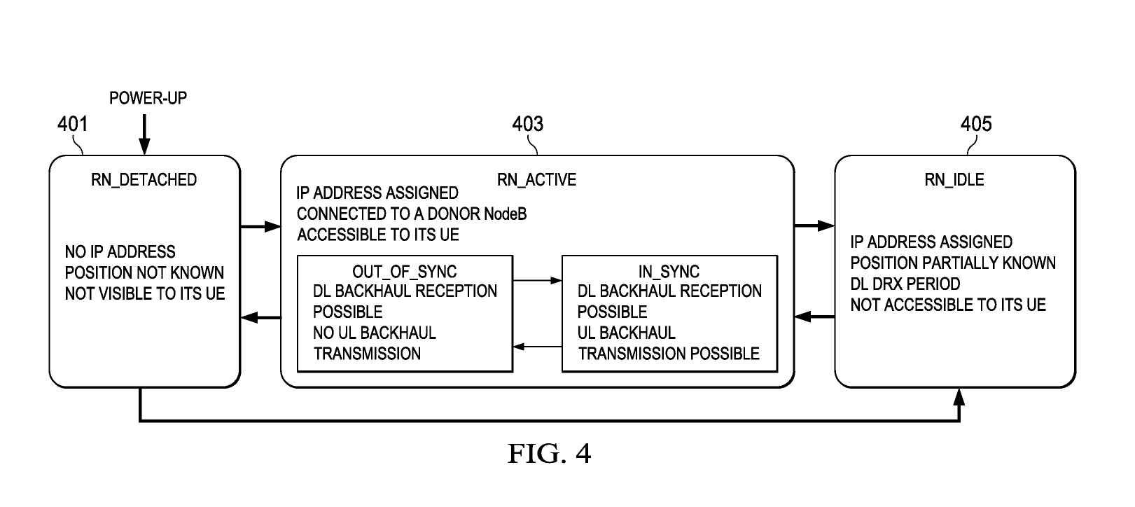

FIG. 4 illustrates states that the first RN 110 may enter as the first RN 110 is behaving like a UE in its communications between the first RN 110 and the base station 105. In particular, the first RN 110 may have three states similar to the first UE 115 (described above with respect to FIG. 3) in order to power on, attach to the base station 105, perform cell searches, perform measurements, or the like. For example, the first RN 110 may have an “RN DETACHED” state 401, an “RN ACTIVE” state 403, and an “RN IDLE” state 405.

Similar to the “LTE DETACHED” state 301 (see FIG. 3 above), the “RN DETACHED” state 401 may be utilized during power up and start up of the first RN 110. In the “RN DETACHED” state 401 the first RN 110 may have no assigned address and the position of the first RN 110 may not be known to the base station 105. As such, the first UE 115 may be “detached” from the base station 105 and may not be visible to the first UE 115 or the second UE 116.

Once the first RN 110 communicates with the base station 105, is assigned an address, such as an IP address, and is connected to the base station 105 for receiving and transmitting, the first RN 110 may enter into and operate in the “RN ACTIVE” state 403. In the “RN ACTIVE” state 403, the first RN 110 may be actively receiving and transmitting data packets from and to the base station 105 and is also accessible to the UEs connected to it (e.g., first UE 115 and second UE 116), actively receiving and transmitting data packets from and to the UEs connected to it (e.g., first UE 115 and second UE 116), and relaying data packets from the base station 105 to the UEs connected to it. Furthermore, if the first RN 110 is in synchronization with the base station 105, the first RN 110 may receive DL backhaul transmissions while also transmitting over the UL backhaul link. If the first RN 110 is out of synchronization with the base station 105, the first RN 110 may receive DL transmissions from the base station 105.

Additionally, the first RN 110 may have the “RN IDLE” state 405 during which the first RN 110 may not be transmitting or receiving packets. In the “RN IDLE” state 405, no context about the first RN 110 is stored in the base station 105. During the “RN IDLE” state 405, the base station 105 may partially lose the position of the first RN 110 while the first RN 110 still has the IP address assigned to it. During the “RN IDLE” state 405, the first RN 110 idles itself until it can re-establish communication with either the base station 105 to which it had been attached or else can establish communication with another base station (not shown), for example in a handoff situation. During this “RN IDLE” state 405 the first RN 110 is not accessible to the first UE 115.

Also shown in FIG. 4 is the movement of the first RN 110 between the different states. As illustrated, the first RN 110 may move between any of the states to any of the other states. For example, the first RN 110 may move from the “RN ACTIVE” state 403 to either the “RN IDLE” state 405 or the “RN DETACHED” state 401, depending upon, e.g., the transmitting and receiving characteristics, such as when the first RN 110 experience a radio link failure (RLF). Additionally, the first RN 110 may transfer from the “RN DETACHED” 401 state to the “RN IDLE” state if conditions warrant, or may transfer from the “RN IDLE” state 405 to the “RN DETACHED” state 401 if, e.g., the first RN 110 attempts to recover but the establishing fails.

However, as the first RN 110 moves from the “RN ACTIVE” state 403 to one of the other states, the first UE 115 may experience a service disruption. Therefore, a mechanism may be used to notify the first UE 115 on those occasions that the first RN 110 may enter the “RN IDLE” state 405 and become inactive towards the first UE 115. Such a mechanism may include the transmission of a notification message from the first RN 110 to the UEs that the first RN 110 is servicing (such as the first UE 115 and the second UE 116 illustrated in FIG. 1 above).

The notification message may be used to provide, e.g., the first UE 115, with information related to the first RN 110's entering and exiting the “RN IDLE” state 405. For example, the notification message may include timing information such as when the first UE 115 will switch its status to another state (such as the “RN IDLE” state 405), how long the first RN 110 will remain in another state, when the first RN 110 will switch back to its current state, how often the first RN 110 needs to switch states, combinations of these, and the like. This timing information may be provided explicitly or, alternatively, may be provided implicitly such that the first UE 115 may be able to determine the information from the information contained within the notification message.

In one embodiment, the notification message may be included as part of a non-dedicated broadcast that is sent and received by each UE being serviced by the first RN 110. Such a non-dedicated broadcast may be in the form of a system information block (SIB) that periodically transmits system information to the various UEs. The information relating to the movement of the first RN 110 may include such information as the periodicity and the starting system frame number (SFN) of the movement. Such an SIB may be broadcast infrequently, such as every 160 ms or more, in order to minimize any potential disruptions.

Alternatively, the information related to the movement of the first RN 110 may be sent by the first RN 110 in a dedicated signal to each of the individual UEs that it is servicing, such as the first UE 115 and the second UE 116 illustrated in FIG. 1 above. This alternative method is useful when the first RN 110 is servicing a small number of UEs, such as between about 1 and about 10 UEs. If the number of UEs is small, it is possible for the first RN 110 to send the notification message to each of the individual UEs.

Once the UEs (such as the first UE 115) receive the notification message, the UEs may prepare for the transit of the first RN 110 into the “RN IDLE” state 405. If the first RN 110 will transfer back to the “RN ACTIVE” state 403 within a short amount of time, such as between about 30 ms and about 60 ms, the UEs may take advantage of this short period of non-accessibility to measure other base stations 105 or even other radio access technologies (RAT) and report to the first RN 110 when it reenters the “RN ACTIVE” state 403. Alternatively, the UEs may enter the “LTE IDLE” state 305 (described above with respect to FIG. 3) while the first RN 110 is in the “RN IDLE” state 405. However, if the first RN 110 will remain in the “RN IDLE” state 405 for a longer time, such as greater than about 120 ms, the UEs may search and attach to other base stations (not shown), other RNs, or even other RATs.

Additionally, the notification message may be modified in order to help ensure backwards compatability with previous released standards, such as Rel-8 standards. Under these earlier standards, previous versions of UEs may receive the notification message as described above, but be unaware of its significance, thereby experiencing a service interruption. Such backwards compatability may still be maintained however, by adjusting the notification message sent to these UEs. In such instances the first RN 110 may notify the earlier release UEs to perform an inter-frequency and/or inter-RAT measurement. While the earlier release UEs are busy performing this measurement, the first RN 110 may excuse itself to enter the “RN IDLE” state 405, perform any necessary actions, and then return to the “RN ACTIVE” state 403 before the earlier release UEs finish the measurement.

Once the first RN 110 has transmitted the notification message to, e.g., the first UE 115, the first RN 110 may enter the “RN IDLE” state 405. When the first RN 110 goes into the “RN IDLE” state, the first RN 110 does not go idle as a regular UE. Rather, the first RN 110 can fallback to UE mode and perform self-serving functions, such as using contention-based random access procedure via a random access channel (RACH) to contact the base station 110 for re-establishment, any measurements that may be desired (for example, measuring a channel condition between the first RN 110 and the base stations 110 close to it so that the first RN 110 can determine the best base station 110 to attach to), other maintenance type of functions, any handoff routines, combinations of these, or the like.

By setting up the “RN IDLE” state 405 along with a notification message from the first RN 110 to the UEs, the first RN 110 may go idle without causing a disruption to the UEs that the first RN 110 is servicing. This may become especially important when the first RN 110 is mobile and needs to perform a handoff routine from one base station to another base station.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for transmitting data to a first piece of user equipment, the method comprising:
wirelessly transmitting a first data packet from a relay node, the relay node being in a first state; and
entering the relay node to a second state different from the first state, wherein the relay node is not accessible in the second state.

2. The method of claim 1, wherein the second state is a detached state.

3. The method of claim 1, wherein the second state is an idle state.

4. The method of claim 3, wherein the relay node enters the idle state after transmitting a second data packet from the relay node, the second data packet comprising information that the relay node is to enter the idle state.

5. The method of claim 4, wherein the second data packet is transmitted in a dedicated transmission.

6. The method of claim 4, wherein the second data packet is transmitted in a broadcast transmission.

7. The method of claim 1, wherein the relay node performs at least part of a handoff procedure while in the second state.

8. The method of claim 1, wherein the relay node is a mobile relay node.

9. The method of claim 1, further comprising performing a random access via a random access channel for establishing communication with a base station when the relay node is in the second state.

10. The method of claim 9, wherein the relay node enters a third state to attempt to recover if the establishing fails.

11. The method of claim 9, wherein the relay node recovers and starts to serve its user equipments if the establishing is successful.

12. The method of claim 1, further comprising performing measurements between the relay node and a base station.

13. A method for receiving data from a relay node, the method comprising:
receiving a first data packet from the relay node, the receiving being performed wirelessly; and
receiving a notification message, the notification message comprising a notice of unavailability.

14. The method of claim 13, further comprising the relay node entering an idle state after transmitting the notification message.

15. The method of claim 13, wherein the notification message comprises an indication of time that the relay node will be unavailable.

16. A system for transmitting data, the system comprising:
a relay node, wherein the relay node is configured to enter into a second mode from a first mode; and
a wireless transmitter coupled to the relay node, the transmitter configured to transmit a message comprising information regarding the relay node entering the second mode.

17. The system of claim 16, wherein the first mode is an active mode.

18. The system of claim 16, wherein the second mode is an idle mode.

19. The system of claim 16, wherein the relay node is further configured to perform a random access using the random access channel (RACH) in the second mode.

20. The method of claim 16, further comprising a wireless receiver coupled to the relay node, the wireless receiver configured to perform measurements between the relay node and a base station when the relay node is in the second mode.
